(19) United States
(12) Patent Application Publication
(10) Pub. No.: US 2013/0212182 A1
(43) Pub. Date: Aug. 15, 2013

(54) METHOD AND SYSTEM FOR COLLABORATIVELY OPERATING SHARED CONTENT IN A VIDEO CONFERENCE

(71) Applicant: Quanta Computer Inc., (US)

(72) Inventors: Jr-Hau Jhang, Kuei Shan Hsiang (TW); Cheng-Yuan Chiu, Kuei Shan Hsiang (TW); Yang-Sheng Wang, Kuei Shan Hsiang (TW)

(73) Assignee: QUANTA COMPUTER INC., Kuei Shan Hsiang (TW)

(21) Appl. No.: 13/751,293

(22) Filed: Jan. 28, 2013

(30) Foreign Application Priority Data
Feb. 13, 2012 (TW) 101104493

(51) Int. Cl. H04L 29/06

(52) U.S. Cl. CPC H04L 65/403
USPC 709/205

(57) ABSTRACT

The disclosure provides a method for collaboratively operating shared content in a video conference, wherein the shared content is shared by a sharing terminal to a shared terminal. In the method, an operation event is transmitted by the shared terminal to the sharing terminal. The operation event is then transmitted to a virtual device of the sharing terminal, and the operation event is performed on the shared content by the virtual device.

### CROSS REFERENCE TO RELATED APPLICATIONS

This Application claims priority of Taiwan Patent Application No. 101104493, filed on Feb. 13, 2012, the entirety of which is incorporated by reference herein.

### BACKGROUND OF THE INVENTION

1. Field of the Invention

The invention relates to a video conferencing system, and more particularly to collaborative operation in a video conference.

2. Description of the Related Art

In a video conference, when a sharing terminal shares content such as a document, a presentation file, a screenshot, etc., to the shared terminals in the video conference, the operational input on the shared content from one of the shared terminals (such as using a mouse to indicate a paragraph of the shared content, or modifying words) usually cannot be presented instantaneously to the sharing terminal, or to the other shared terminals. Even if access authority for the shared content is granted to the shared terminals, operational inputs from different shared terminals may be in conflict when more than two shared terminals perform operations on the shared content at the same time. Therefore, the shared terminals have to perform their operations in turn, and thus the video conference may be interrupted or falter.

### BRIEF SUMMARY OF THE INVENTION

In view of the above, the invention provides a method for collaboratively operating shared content in a video conference. With the help of virtual devices, each of which corresponds to one user, operational input from different users can be performed on the shared content simultaneously and the shared content can be shared to all users instantaneously so as to allow all users to immediately view the results of the operational input. Thus, collaborative operation of the shared content is achieved.

An embodiment of the invention provides a method for collaboratively operating shared content in a video conference, wherein the shared content is shared by a sharing terminal to a shared terminal, the method comprising: transmitting an operation event by the shared terminal to the sharing terminal; transmitting the operation event to a virtual device of the sharing terminal; and performing the operation event on the shared content by the virtual device.

Another embodiment of the invention provides a video conferencing system, including a sharing terminal and a shared terminal, wherein the sharing terminal and the shared terminal are connected to each other through a network. The sharing terminal comprises: a sharing unit, sharing shared content to the shared terminal through the network; a process unit, receiving an operation event from the shared terminal through the network; and a virtual device system, receiving the operation event from the process unit and assigning the operation event to a virtual device which performs the operation event on the shared content. The shared terminal comprises: a shared unit, receiving the shared content through the network and displaying the shared content on the display unit of the shared terminal; and a detect/retrieve unit, detecting the operation event, retrieving the operation event, and transmitting the operation event to the process unit through the network.

Still another embodiment of the invention provides a computer program embodied in a non-transitory computer-readable storage medium, such as a floppy diskette, CD-ROM or hard drive, wherein the computer program is loaded into and executed by an electronic device for performing a method for collaboratively operating shared content in a video conference, the computer program comprising: a first code for setting shared content, which is shared by a sharing terminal to a shared terminal, to be able to be operated collaboratively; a second code for directing the shared terminal to determine whether the operation event is performed within an active region of the shared content according to coordinates of the operation event in the shared terminal and, if so, directing the shared terminal to normalize the coordinates to generate normalized coordinates and transmit the operation event to the sharing terminal; a third code for directing the sharing terminal to determine whether the shared content is able to be operated collaboratively and, if so, directing the sharing terminal to determine performing coordinates, which are used when the operation event is performed on the shared content according to the normalized coordinates, and transmit the operation event to a virtual device of the sharing terminal; and a fourth code for directing the virtual device to perform the operation on the shared content according to the performing coordinates.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a video conferencing system according to an embodiment of the invention;

FIG. 2a is a flowchart of a method for collaboratively operating shared content by a sharing terminal in a video conference according to an embodiment of the invention;

FIG. 2b is a flowchart of a method for collaboratively operating shared content by a shared terminal in a video conference according to an embodiment of the invention;

FIG. 3 is a flowchart of a method for collaboratively operating shared content in a video conference according to an embodiment of the invention;

FIG. 4a and FIG. 4b are block diagrams of a video conferencing system according to an embodiment of the invention; and

FIG. 5a and FIG. 5b are block diagrams of a communication flow for collaboratively operating shared content in a video conference according to one embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

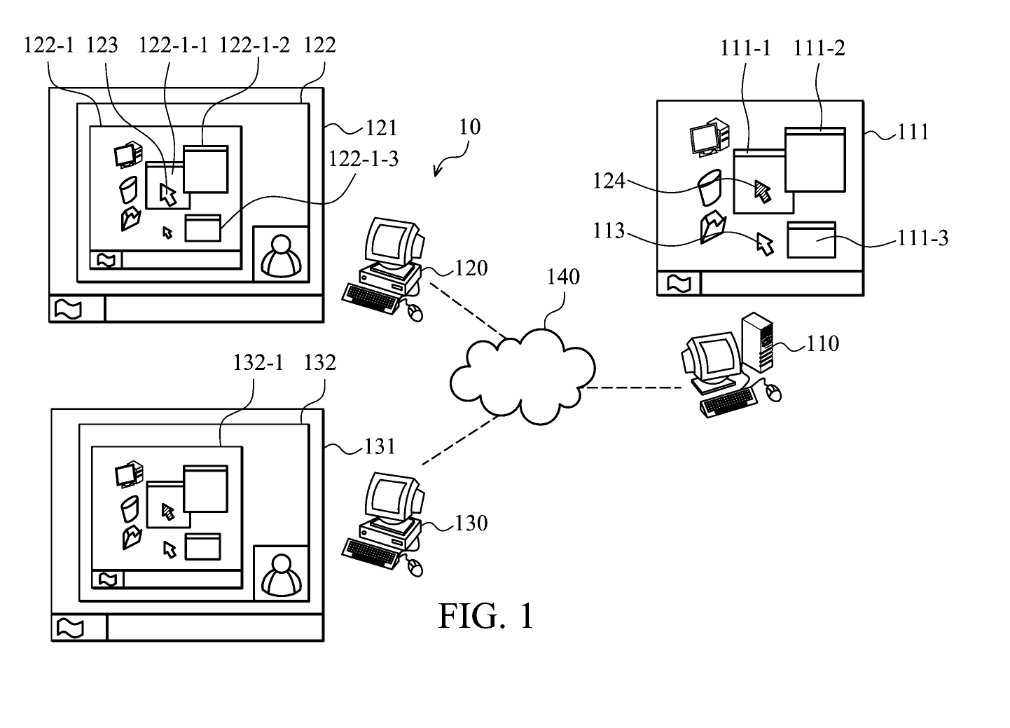

FIG. 1 is a block diagram of a video conferencing system 10 according to an embodiment of the invention. The video conferencing system 10 comprises a sharing terminal 110, shared terminals 120 and 130, and a network 140. The sharing terminal 110 and the shared terminals 120 and 130 are connected to each other through the network 140 so as to perform a video conference. Screenshots 111, 121 and 131 are screenshots of the sharing terminal 110 and the shared terminals 120 and 130, respectively. Windows 111-1, 111-2 and 111-3 are displayed on the screenshots 111. Cursors 113 and 123 belong to the sharing terminal 110 and the shared terminal 120, respectively. The number of sharing terminals and the number of shared terminals in FIG. 1 are only exemplary, and the invention is not limited thereto. Note that any participant (terminal) in the video conference could be a sharing terminal or a shared terminal In addition, the sharing terminal 110 and the shared terminals 120 and 130 are each equipped with a microphone (not shown) and a video camera (not shown) to aid in the video conference.

In the video conference, when the sharing terminal shares the screenshot 111 to the shared terminals 120 and 130, the screenshot 111 is received by the shared terminals 120 and 130 and displayed on a block 122-1 of a video conference program window 122 on the screenshot 121 and a block 132-1 of a video conference program window 132 on the screenshot 131. The windows 111-1, 111-2 and 111-3 correspond to blocks 122-1-1, 122-1-2 and 122-1-3 in the block 122-1, respectively. Similarly, the windows 111-1, 111-2 and 111-3 also respectively correspond to blocks in the block 132-1.

When authority for collaborative operation is granted to the shared terminal 120 by the sharing terminal 110, the sharing terminal 110 generates a virtual cursor 124 corresponding to the shared terminal 120. The authority for collaborative operation gives the shared terminal the authority to not only explore but also edit the shared content. In addition, if the sharing terminal 110 shares the screenshot 111 to the shared terminal 130 but the authority for collaborative operation is not granted to the shared terminal 130, a virtual cursor corresponding to the shared terminal 130 is not generated on the screenshot 111 of the sharing terminal 110. Cursors respectively corresponding to the sharing terminal 110 and the shared terminal 120 (with the authority for collaborative operation) are shown on the video conference program window 132 of the shared terminal 130.

In a specific embodiment, when the user of the shared terminal 120 performs an operation by any input device (such as a mouse or a touch pad) to move the cursor 123, the shared terminal 120 detects an operation event of the input device (which may be referred to as a mouse-operation event in the following), and transmits the operation event to the sharing terminal 110. Then the sharing terminal 110 generates the virtual cursor 124 in response to the operation event.

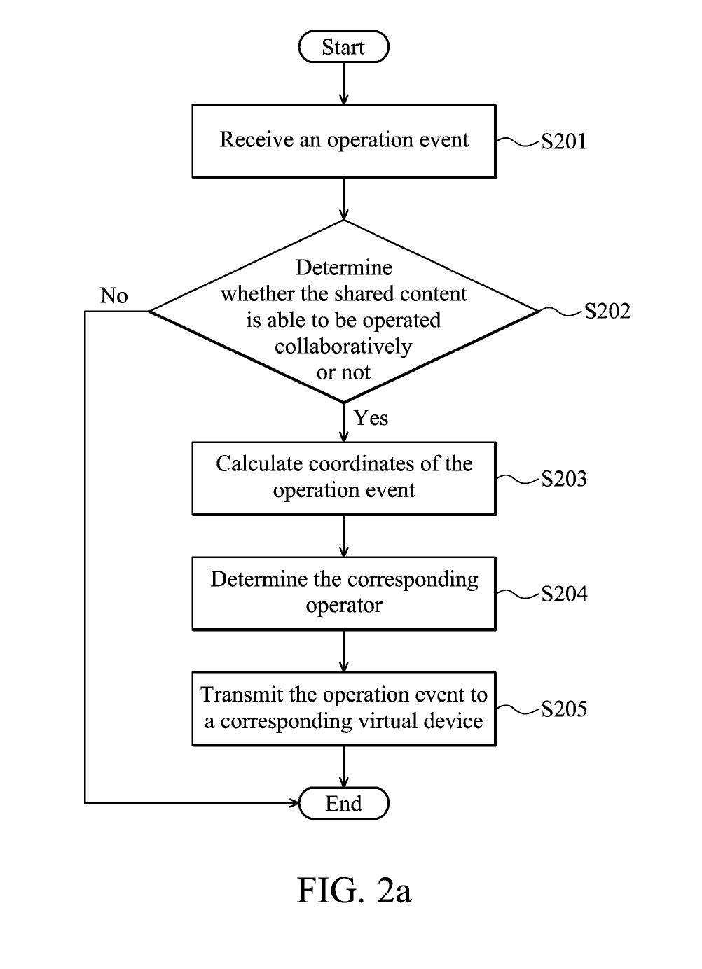

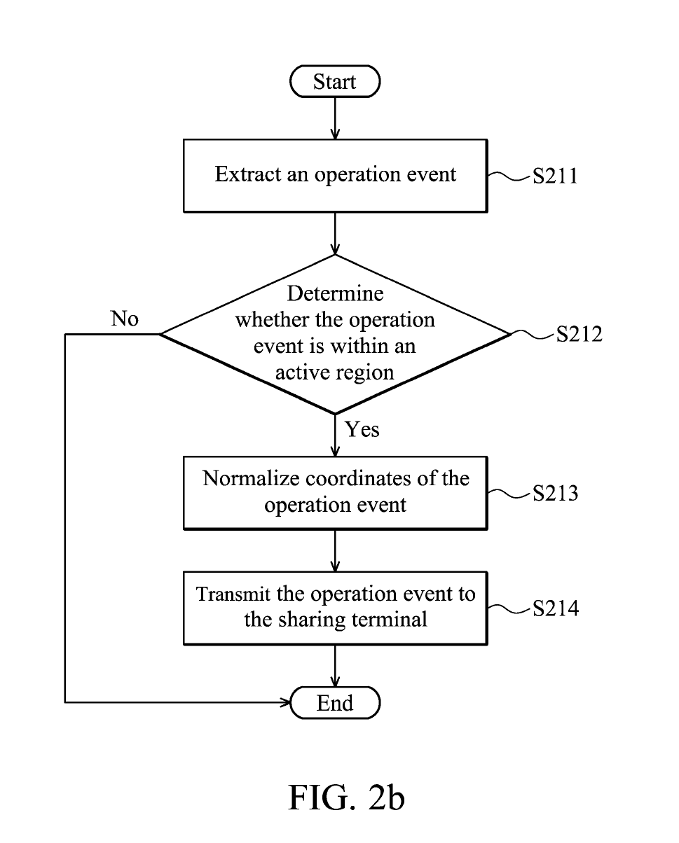

Referring specifically to FIG. 1, the virtual cursor 124 corresponding to the cursor 123 of the shared terminal 120 is shown on the screenshot 111 of the sharing terminal 110. Virtual operations of the virtual cursor 124 are the same as the operations (such as moving, left-clicking, right-clicking, or double-clicking) of the cursor 123 of the shared terminal 120. Moreover, the position of the virtual cursor 124 relative to the screenshot 111 is the same as the position of the cursor 123 relative to the block 122-1. Therefore, the operation event performed in the shared terminal 120 can be presented on the sharing terminal 110 and the shared terminal 130. Note that the shared content of the sharing terminal 110 is not limited to the screenshot. The shared content can be a document, a presentation file, an extended desktop, screenshots of display devices other than the main screen, or pictures of windows, applications, etc. The operation event is not limited to the mouse-operation event. The operation event can be drawing, the modification of text, etc. The collaborative operation described above will be explained in detail with reference to FIGS. 2a, 2b, 3 and 4 by an example wherein a mouse is the input device.

FIG. 2a is a flowchart of a method for collaboratively operating shared content by a sharing terminal in a video conference according to an embodiment of the invention. In step S201, the sharing terminal receives a mouse-operation event, such as the mouse-operation event received by the sharing terminal 110 and transmitted by the shared terminal 120. In step S202, it is determined whether or not the shared content is able to be operated collaboratively. For example, it is determined whether or not the authority for collaborative operation of the screenshot 111 is granted. If the shared content is not able to be operated collaboratively (step S202: No), the method ends. If the shared content is able to be operated collaboratively (step S202: Yes), coordinates of the mouse-operation event are calculated in step S203. For example, since sizes and proportions of display devices of the sharing terminal and shared terminals in the video conference may be different and, for example, the size of the block 122-1 corresponding to the screenshot 111 shared to the shared terminal 120 is different from the size of the actual screenshot 111 as shown in FIG. 1, the coordinates of the mouse cursor 123 relative to the block 122-1 have to be converted so that the position of the virtual cursor 124 relative to the screenshot 111 corresponds to the position of the mouse cursor 123 relative to the block 122-1.

Then, in step S204, the operator corresponding to the received mouse-operation event is determined For example, the sharing terminal 110 determines which shared terminal the received mouse-operation event corresponds to. A method for determining which shared terminal the received mouse-operation event corresponds to can be carried out in different ways. In one example, the sharing terminal shares the screenshot 111 to the shared terminals through one-to-one channels. Thus, the sharing terminal may determine which shared terminal the received mouse-operation event corresponds to by determining which channel the received mouse-operation event is transmitted through. In other examples, the sharing terminal 110 may determine which shared terminal produced the received mouse operation according to a source IP address or the like contained in a transmitting signal for transmitting the mouse-operation event.

In step S205, the mouse-operation event is transmitted to a corresponding virtual device (a virtual mouse) to direct the virtual device to perform the mouse-operation event. For example, the mouse-operation event is transmitted to a virtual mouse corresponding to the shared terminal 120, and the virtual mouse performs the mouse-operation event. That is, in practice, the virtual cursor 124 is displayed on the screenshot 111 of the sharing terminal 110 and the mouse-operation event (such as moving, left-clicking, right-clicking, or double-clicking) is performed through the virtual cursor 124. Note that the virtual device is not limited to the virtual mouse. The virtual device may refer to any virtual human interface device according to the operation event. After step S205, the method ends. The next time that the sharing terminal receives a mouse-operation event, the method is repeated.

FIG. 2b is a flowchart of a method for collaboratively operating shared content by a shared terminal in a video conference according to an embodiment of the invention.

In step S211, the shared terminal extracts an operation event. For example, when the user of the shared terminal 120 moves the mouse, the shared terminal 120 detects the movement of the mouse and extracts the mouse-operation event. Then in step S212, it is determined whether the operation event is within an active region. The operation event being within the active region means that the cursor 123 is within the block 122-1 corresponding to the screenshot 111. For example, as shown in FIG. 1, the size of the block 122-1 corresponding to the screenshot 111 shared to the shared terminal 122 is different from the size of the actual screenshot 111 of the sharing terminal 110. Only the region within the block 122-1 corresponds to the region within the screenshot 111. Therefore, whether the cursor 123 is within the region of the block 122-1 has to be determined. If the mouse-operation event is within the active region (Step S212: Yes), the mouse-operation event is an effective operation for the screenshot 111. If the mouse-operation event is not within the active region (Step S212: No), the mouse-operation event is not an operation for the screenshot 111, and the method ends.

If the operation event is within the active region (Step S212: Yes), that is, if the cursor 123 is within the block 122-1 corresponding to the screenshot 111, coordinates of the operation event are normalized in step S213. For example, as described above, since the sizes and proportions of the display devices of the sharing terminal and shared terminals in the video conference may be different and the size of the block 122-1 corresponding to the screenshot 111 shared to the shared terminal 122 is different from the size of the actual screenshot 111 as shown in FIG. 1, the coordinates of the cursor 123 relative to the block 122-1 has to be normalized so as to be converted into the coordinates of the virtual cursor 124 relative to the screenshot 111 by the sharing terminal 110. Therefore, the position of the virtual cursor 124 relative to the screenshot 111 can correspond to the position of the mouse cursor 123 relative to the block 122-1. In an example of the coordinate normalization, the X-coordinate of the cursor 123 relative to the block 122-1 is normalized to be in the interval [−1, 1], and the Y-coordinate of the cursor 123 relative to the block 122-1 is normalized to be in the interval [−1, 1]. Step S213 corresponds to step S203. That is, the normalized X-coordinate and the normalized Y-coordinate can be multiplied by the amplitude along the X-axis (such as 1024 pixels) and the amplitude along the Y-axis (such as 768 pixels) of the screenshot 111, respectively, in step S203 so as to obtain the coordinates of the virtual cursor 124 relative to the screenshot 111 (the performing coordinates).

In step S214, the operation event is transmitted to the sharing terminal For example, the shared terminal 120 transmits the mouse-operation event to the sharing terminal 110, and then the method ends. Next time, when the shared terminal detects another operation event, the method will be repeated. The invention is not limited to the steps in FIG. 2a and FIG. 2b, and the steps may be modified according to the situation in practice. For example, a step for determining whether the shared content is able to be operated collaboratively, similar to the step S202, can be inserted into the steps S211 and S212, or the order of the steps S203 and S204 can be exchanged.

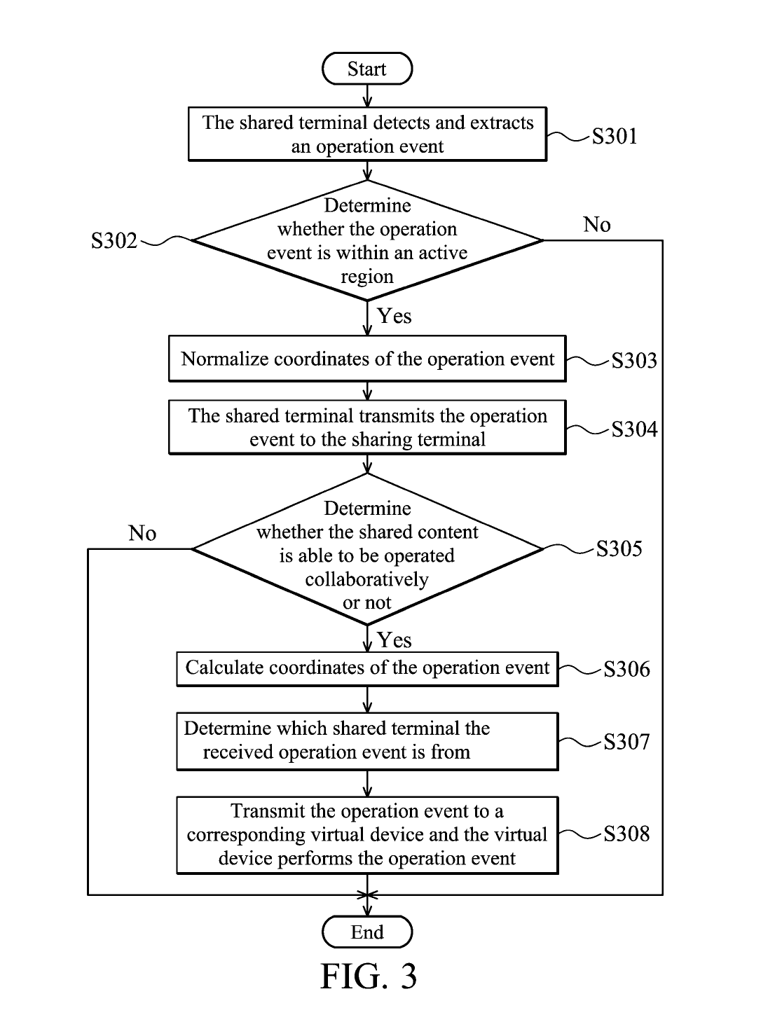

FIG. 3 is a flowchart of a method 30 for collaboratively operating shared content in a video conference according to an embodiment of the invention. The method in FIG. 3 is a combination of the methods in FIG. 2a and FIG. 2b, and thus the similar parts will not be described again.

After shared content is shared to shared terminals by a sharing terminal, if one of the shared terminals performs an operation on the received shared content, the method in FIG. 3 is performed. In step S301, the shared terminal detects an operation event and extracts the operation event. In step S302, whether the operation event is within an active region is determined If the operation event is not within the active region (Step S302: No), the method 30 ends. If the operation event is within the active region (Step S302: Yes), coordinates of the operation event are normalized in step S303. Then in step S304, the shared terminal transmits the operation event to the sharing terminal In step S305, after the sharing terminal receives the operation event, the sharing terminal determines whether the shared content is able to be operated collaboratively. If the shared content is not able to be operated collaboratively (Step S305: No), the method 30 ends. If the shared content is able to be operated collaboratively (Step S305: Yes), the sharing terminal converts the coordinates of the operation event. In step S307, the sharing terminal determines which shared terminal the received operation event is from. Then in step S308, the operation event is transmitted to a virtual device to make the virtual device perform the operation event. Next time when any one of the shared terminals performs another operation event, the method 30 will be repeated.

Though the operation event of one shared terminal is described above, it will be apparent to those skilled in the art that the method for collaborative operation can be reasonably applied to a situation in which multiple shared terminals perform their operations on the shared content. Since each shared terminal corresponds to one virtual device, there is no conflict even though multiple shared terminals perform their operations on the shared content at the same time. Furthermore, when multiple shared terminals perform their respective mouse operations, virtual cursors displayed on the screenshot 111, each of which corresponds to a respective shared terminal, may have different colors or be indicated by different annotations according to their respective corresponding shared terminals. Therefore, all users in the video conference can clearly understand each virtual cursor corresponds to which user.

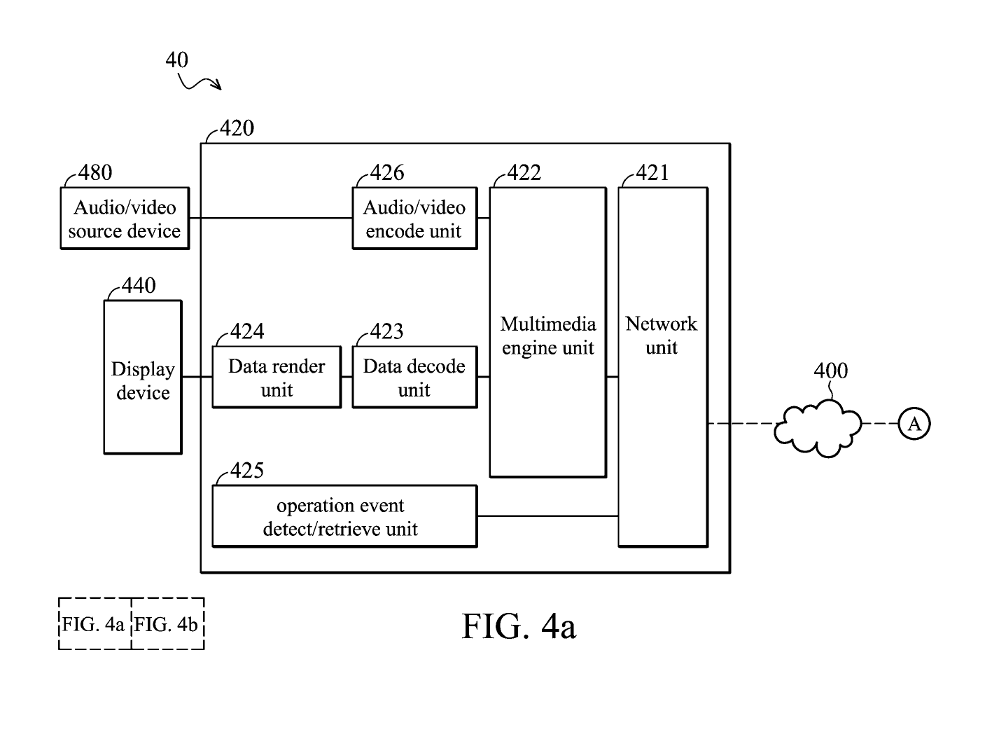

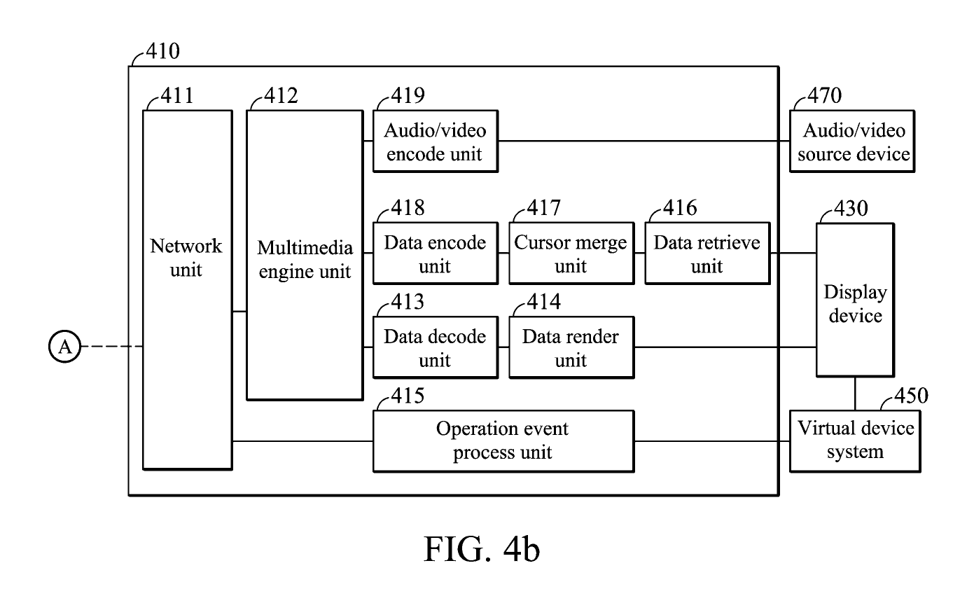

FIG. 4a and FIG. 4b show block diagrams of a video conferencing system 40 according to an embodiment of the invention. The video conferencing system 40 comprises a sharing terminal 410 and a shared terminal 420. The sharing terminal 410 and the shared terminal 420 are connected to each other through a network 400. The sharing terminal 410 and the shared terminal 420 are process devices with audio/video processing functions, such as a host of a desktop computer. The sharing terminal 410 is coupled to an audio/video source device 470, a display device 430, and a virtual device system 450. The shared terminal 420 is coupled to an audio/video source device 480 and a display device 440. The sharing terminal 410 comprises a network unit 411, a multimedia engine unit 412, a data decode unit 413, a data render unit 414, an operation event process unit 415, a data retrieve unit 416, a cursor merge unit 417, a data encode unit 418 and an audio/video encode unit 419. The shared terminal comprises a network unit 421, a multimedia engine unit 422, a data decode unit 423, a data render unit 424, an operation event detect/retrieve unit 425 and an audio/video encode unit 426.

The multimedia engine unit 412 of the sharing terminal 410 transmits shared content of the sharing terminal 410 to the multimedia engine unit 422 of the shared terminal 420 through the network unit 411, the network 400 and the network unit 421. Then the shared content (such as the screenshot 111) is decoded by the data decode unit 423. The decoded shared content is then rendered on the display device 440 through the data render unit 424.

For example, in a video conference, when the sharing terminal 410 wants to share a display picture of the display device 430, firstly, the audio/video source device 470 retrieves audio signals of a microphone and video signals of a video camera and the retrieved signals are then encoded through the audio/video encode unit 419. Next, the data retrieve unit 416 retrieves data or picture displayed on the display device 430, and then the retrieved data is encoded through the data encode unit 418. Afterwards, the audio/video data encoded by the audio/video encode unit 419 and the data encoded by the data encode unit 418 are transmitted by the multimedia engine unit 412 to the multimedia engine unit 422 of the shared terminal 420 through the network unit 411, the network 400 and the network unit 421. The multimedia engine unit 422 transmits the received data of the shared content to the data decode unit 423 for decoding. Then the data render unit 424 renders the decoded data of the shared content on the display unit 440. In on specific embodiment, the display device 440 displays the shared content of the display device 430 and decodes and displays the audio/video signals from the audio/video source device 470 of the sharing terminal 410, such as pictures and voice of the user of the sharing terminal 410. Similarly, the display device 430 of the sharing terminal 410 displays the shared content as well as decoding and displaying the audio/video signals from the audio/video source device 480 of the shared terminal 420 through the data decode unit 413 and data render unit 414, which are encoded by the audio/video encode unit 426 and may include pictures and voice of the user of the shared terminal 420.

The operation event detect/retrieve unit 425 is coupled to a human interface device such as a mouse or a keyboard. When the operation event detect/retrieve unit 425 detects an occurring operation event, such as the movement of a mouse, the operation event detect/retrieve unit 425 retrieves the operation event and performs basic processes on the retrieved operation event. The basic processes may comprise determining whether the operation event is within an active region, normalizing coordinates of the operation event, and so on. Then the processed operation event is encapsulated into an operation event signal by the operation event detect/retrieve unit 425. The operation event signal is transmitted to the operation event process unit 415 of the sharing terminal 410 through the network unit 421, the network 400 and the network unit 411. The operation event process unit 415 determines whether the shared content is able to be operated collaboratively, converts the coordinates of the operation event, determines which shared terminal the shared content is from, and transmits the operation event to the virtual device system 450. A virtual device in the virtual device system 450, which receives the operation event, performs the operation event.

For example, when the operation event detect/retrieve unit 425 detects a movement of the mouse, the operation event detect/retrieve unit 425 retrieves the mouse-operation event, determines whether the mouse-operation event is within the active region, normalizes the coordinates of the mouse-operation event, encapsulates the mouse-operation event into a mouse-operation event signal, and then transmits the mouse-operation event signal to the operation event process unit 415 of the sharing terminal 410 through the network unit 421, the network 400 and the network unit 411.

After receiving the mouse-operation event, the operation event process unit 415 determines whether the current shared content is able to be operated collaboratively. If the current shared content is not able to be operated collaboratively, the mouse-operation event is not processed. If the current shared content is able to be operated collaboratively, the following processes are performed. The operation event process unit 415 converts the coordinates of the mouse-operation event, determines which shared terminal the mouse-operation event is from, and then transmits the mouse-operation event to the virtual device system 450. The virtual device system 450 generates a virtual mouse (and coordinates of a virtual mouse cursor of the virtual mouse) corresponding to the mouse-operation event and directs the virtual mouse to perform the mouse-operation event so as to display the virtual mouse cursor corresponding to the shared terminal 420 on the display device 430 and to display the mouse-operation event through the virtual mouse cursor as ones performed in the shared terminal 420. In a specific embodiment, when the current shared content is determined to be able to be operated collaboratively by the operation event process unit 415, the virtual device system 450 generates the virtual mouse (and the coordinates) corresponding to the mouse-operation event. In another specific embodiment, when the sharing terminal shares the display screen and grants authority for collaborative operation of the display screen, the virtual device system 450 generates the virtual mouse (and the coordinates) corresponding to the mouse-operation event.

Furthermore, the data retrieve unit 416 keeps retrieving data displayed on the display device 430. The cursor merge unit 417 merges the data displayed on the display device 430, the mouse cursor of the sharing terminal 410 and the virtual mouse cursor of the virtual mouse together. The merged data is then transmitted to the shared terminal 420 and other shared terminals. In this way, the operation events of all shared terminals can be wholly transmitted to all shared terminals. Therefore, according to the system and the method described above, the operations of all users in a video conference can be received simultaneously and thus collaborative operation of shared content in the video conference is achieved.

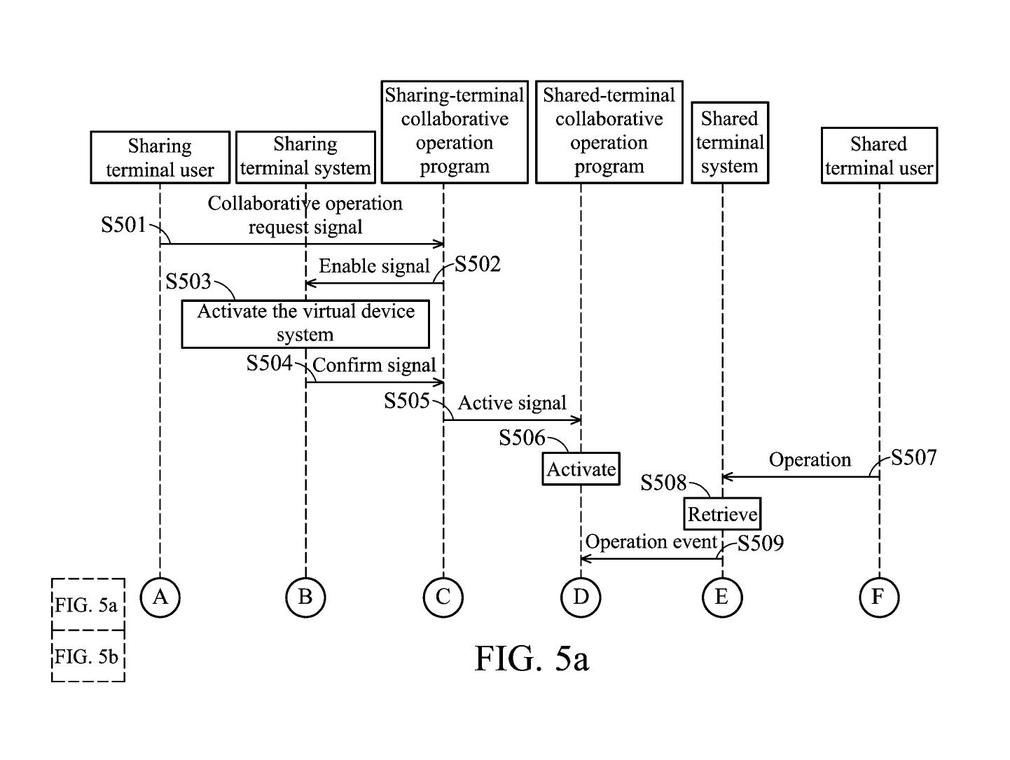

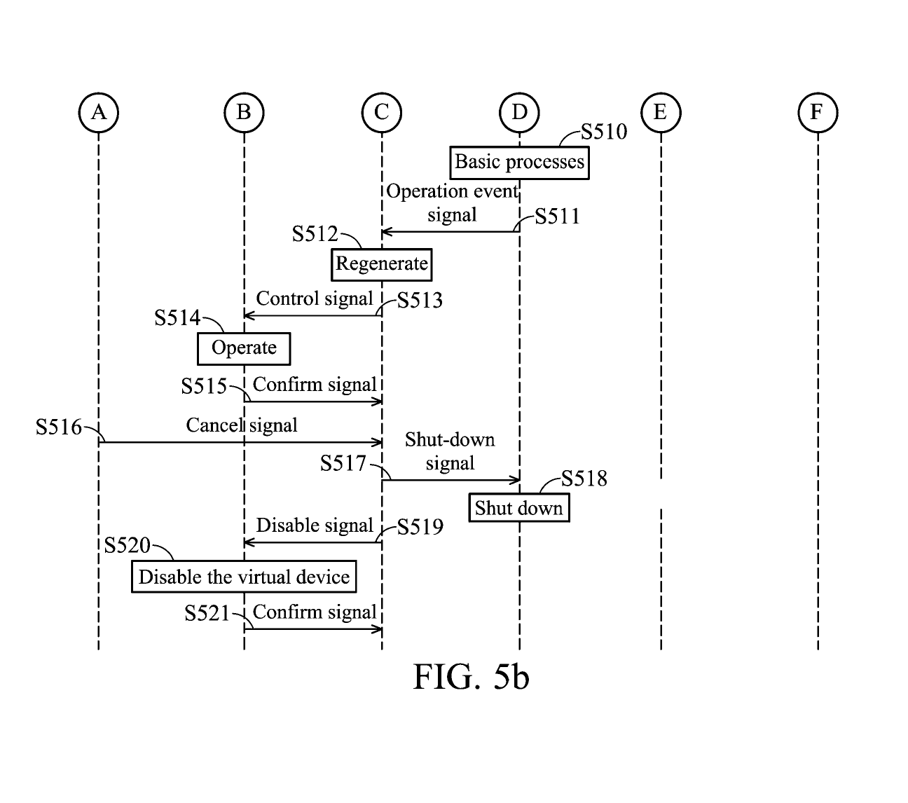

FIG. 5a and FIG. 5b are block diagrams of a communication flow for collaboratively operating shared content in a video conference according to one embodiment of the invention.

A collaborative operation request signal is triggered (step S501) when the user of a sharing terminal requests collaborative operation in a video conference, such as by pressing a shortcut key. The sharing-terminal collaborative operation program, which is installed in the sharing terminal, receives the collaborative operation request signal and transmits an enable signal to the sharing terminal system (step S502). The sharing terminal system comprises the sharing terminal 410, the display device 430, and the virtual device system 450 in FIG. 4b. After the sharing terminal system receives the enable signal, the virtual device system is activated (step S503). After the activation of the virtual device system, a confirm signal is transmitted to the sharing-terminal collaborative operation program (step S504). Then the sharing-terminal collaborative operation program transmits an active signal to the shared-terminal collaborative operation program which is installed in a shared terminal through a network (step S505), so as to activate the shared-terminal collaborative operation program (step S506).

When the user of the shared terminal performs a mouse operation (step S507), the shared terminal retrieves an operation event corresponding to the mouse operation (step S508) and the operation event is transmitted to the shared-terminal collaborative operation program (step S509). The shared-terminal collaborative operation program performs basic processes on the operation event (step S510), such as determining whether the operation event is within an active region, normalizing the coordinates of the operation event, encapsulating the operation event into an operation event signal, and so on. Then the operation event signal is transmitted to the sharing-terminal collaborative operation program through the network (step S511). The sharing-terminal collaborative operation program regenerates the operation event according to the operation event signal (step S512) by performing actions such as converting the coordinates of the operation event and determining which shared terminal the operation event is coming from. Then the sharing-terminal collaborative operation program transmits a control signal to the sharing terminal system (step S513) to make a corresponding virtual device in the sharing terminal system to perform the operation event (step S514). After the operation event is performed, a confirm signal is sent to the sharing-terminal collaborative operation program (step S515), and thus the collaborative operation is accomplished. If there is another operation event from any shared terminal, steps S506 to S515 are repeated.

When the user of the sharing terminal cancels the collaborative operation function, a cancel signal is transmitted to the sharing-terminal collaborative operation program (step S516). Then the sharing-terminal collaborative operation program transmits a shut-down signal to the shared-terminal collaborative operation program (step S517) to shut the shared-terminal collaborative operation program down (step S518). Then the sharing-terminal collaborative operation program transmits a disable signal to the sharing terminal system (step S519) to disable the virtual device system in the sharing terminal system (step S520). After the virtual device system is disabled, the sharing terminal system responds to the sharing-terminal collaborative operation program with a confirm signal (step S521), and thus the collaborative operation ends.

According to the system and method for collaborative operation as described above, the operations of different users can be performed on shared content simultaneously in a video conference, and the shared content can be immediately shared with all users so as to allow all users to view the operation instantaneously. Therefore, collaborative operation is achieved.

Methods and systems of the present disclosure, or certain aspects or portions of embodiments thereof, may take the form of a program code (i.e., instructions) embodied in media such as floppy diskettes, CD-ROMS, hard drives, firmware, or any other non-transitory machine-readable/computer-readable storage medium, wherein, when the program code is loaded into and executed by a machine such as a computer, the machine becomes an apparatus for practicing the embodiments of the disclosure. The methods and apparatus of the present disclosure may also be embodied in the form of program code transmitted over some transmission medium, such as electrical wiring or cabling, through fiber optics, or via any other form of transmission wherein, when the program code is received and loaded into and executed by a machine such as a computer, the machine becomes an apparatus for practicing the embodiment of the disclosure. When implemented on a general-purpose processor, the program code combines with the processor to provide a unique apparatus that operates analogously to specific logic circuits.

In one embodiment, the invention provides a computer program embodied in a non-transitory computer-readable storage medium, such as a floppy diskette, CD-ROM, or hard drive, wherein the computer program is loaded into and executed by an electronic device for performing a method for collaboratively operating shared content in a video conference, the computer program comprising: a first code for setting shared content, which is shared by a sharing terminal to a shared terminal, to be able to be operated collaboratively; a second code for directing the shared terminal to determine whether the operation event is performed within an active region of the shared content according to coordinates of the operation event in the shared terminal and, if so, directing the shared terminal to normalize the coordinates to generate normalized coordinates and transmit the operation event to the sharing terminal; a third code for directing the sharing terminal to determine whether the shared content is able to be operated collaboratively and, if so, directing the sharing terminal to determine performing coordinates, which are used when the operation event is performed on the shared content according to the normalized coordinates, and transmit the operation event to a virtual device of the sharing terminal; and a fourth code for directing the virtual device to perform the operation on the shared content according to the performing coordinates.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for collaboratively operating shared content in a video conference, wherein the shared content is shared by a sharing terminal to a shared terminal, the method comprising:
transmitting an operation event by the shared terminal to the sharing terminal;
transmitting the operation event to a virtual device of the sharing terminal; and
performing the operation event on the shared content by the virtual device.

2. The method as claimed in claim 1, further comprising:
setting the shared content to be able to be operated collaboratively by the sharing terminal.

3. The method as claimed in claim 2, further comprising:
determining whether the shared content is able to be operated collaboratively and, if so, transmitting the operation event to the virtual device of the sharing terminal.

4. The method as claimed in claim 3, further comprising:
determining whether the operation event is performed within an active region of the shared content according to coordinates of the operation event in the shared terminal and, if so, transmitting the operation event by the shared terminal to the sharing terminal.

5. The method as claimed in claim 4, further comprising:
normalizing the coordinates and generating normalized coordinates for the operation event; and
determining performing coordinates, which are used when the operation event is performed on the shared content, according to the normalized coordinates, and directing the virtual device to perform the operation event on the shared content according to the performing coordinates.

6. A video conferencing system, including a sharing terminal and a shared terminal, wherein the sharing terminal and the shared terminal are connected to each other through a network, wherein the sharing terminal comprises:
a sharing unit, sharing shared content to the shared terminal through the network;
a process unit, receiving an operation event from the shared terminal through the network; and
a virtual device system, receiving the operation event from the process unit and assigning the operation event to a virtual device which performs the operation event on the shared content, and
wherein the shared terminal comprises:
a shared unit, receiving the shared content through the network and displaying the shared content on a display unit of the shared terminal; and
a detect/retrieve unit, detecting the operation event, retrieving the operation event, and transmitting the operation event to the process unit through the network.

7. The video conferencing system as claimed in claim 6, wherein the process unit further determines whether the shared content is able to be operated collaboratively and, if so, transmits the operation event to the virtual device of the virtual device system.

8. The video conferencing system as claimed in claim 7, wherein the detect/retrieve unit further determines whether the operation event is performed within an active region of the shared content according to coordinates of the operation event relative to the shared content and, if so, transmits the operation event to the process unit through the network.

9. The video conferencing system as claimed in claim 8, wherein the detect/retrieve unit further normalizes the coordinates and generates normalized coordinates for the operation event, and the process unit further determines performing coordinates, which are used when the operation event is performed on the shared content, according to the normalized coordinates, and the virtual device performs the operation event on the shared content according to the performing coordinates.

10. A computer program embodied in a non-transitory computer-readable storage medium, wherein the computer program is loaded into and executed by an electronic device for collaboratively operating shared content in a video conference, the computer program comprising:
a first code for setting shared content, which is shared by a sharing terminal to a shared terminal, to be able to be operated collaboratively;
a second code for directing the shared terminal to determine whether the operation event is performed within an active region of the shared content according to coordinates of the operation event in the shared terminal and, if so, directing the shared terminal to normalize the coordinates to generate normalized coordinates and transmit the operation event to the sharing terminal;
a third code for directing the sharing terminal to determine whether the shared content is able to be operated collaboratively and, if so, directing the sharing terminal to determine performing coordinates, which are used when the operation event is performed on the shared content according to the normalized coordinates, and transmit the operation event to a virtual device of the sharing terminal; and
a fourth code for directing the virtual device to perform the operation on the shared content according to the performing coordinates.
